(19) United States
(12) Patent Application Publication
(10) Pub. No.: US 2025/0151665 A1
(43) Pub. Date: May 15, 2025

(54) SECURITY PLANTER AND METHOD OF MANUFACTURING THEREOF

(71) Applicant: Jansen Industrie Inc., Blainville (CA)

(72) Inventor: Jean-Paul JANSEN, St-Sauveur (CA)

(73) Assignee: Jansen Industrie Inc., Blainville (CA)

(21) Appl. No.: 18/941,241

(22) Filed: Nov. 8, 2024

Related U.S. Application Data
(60) Provisional application No. 63/548,071, filed on Nov. 10, 2023.

(51) Int. Cl. A01G 9/02; C09D 5/16

(52) U.S. Cl. CPC A01G 9/02; C09D 5/16

(57) ABSTRACT

A security planter comprises a container having a bottom and at least one groove on at least one external surface of the container, and a first display located in the groove, attached to the container and operatively connected to a controller located inside the container. A method of manufacturing of a security planter, the method comprising: welding a rebar; covering the rebar with concrete to manufacture a container; polishing external surfaces of the container with at least one diamond stone in at least three stages of polishing and then sanding the external surfaces; and after pressure washing and drying the container, applying at least one of a sealer and a coating to the external surfaces of the container.

### RELATED APPLICATION

The present application claims priority to or benefit of U.S. provisional patent application No. 63/548,071, filed Nov. 10, 2023, which is incorporated herein by reference in its entirety.

### TECHNICAL FIELD

The present disclosure relates to containers for plants. More specifically, it relates to planters with safety and security features.

### BACKGROUND

To ensure safety and security of customers and residents, various heavy objects may be used. For example, heavy blocks may be used to delimit spaces such as school yards or parks for protection from intruders. Portable safety barriers or fences, heavy blocks, or cars, including, for example, police cars, may be used to block the access of intruders to festivals or other events. Portable safety barriers are easily displaceable if attacked by an intruder's vehicle. Police cars, if attacked by an intruder's vehicle, is expensive to replace. Heavy blocks may be movable, but are not aesthetically pleasing.

Containers with plants represent an aesthetic and accessible added value all year round, and can be used to decorate and to delimit private or public spaces, and help to improve the appearance of a neighborhood.

### SUMMARY

According to one aspect of the disclosed technology, there is provided a security planter (which is also referred to herein as “planter” or “safety planter”) comprising: a container having a bottom and a groove on a first external surface of a first wall of the container, and a first display located in the groove, attached to the container and operatively connected to a controller located inside the container. The first wall of the container may have a first internal surface inside the container, and the first internal surface may have a first step configured to thicken a width of the first wall around a groove area and along the wall while keeping a narrower external edge of the container wall. The planter may have a second groove located on a second external surface on a second wall of the container and having a second display located within the second groove, the second display being connected to the controller.

A second internal surface of the second wall inside the container may have a second step configured to thicken a width of the second wall around a groove area and along the wall while keeping a narrower external edge of the second wall. The controller may be configured to operate wirelessly. A bottom width of the bottom of the container may be thicker than the first wall.

A second wall of the planter has a second external surface and a second internal surface, the second internal surface may comprise at least two flat surfaces providing different angles with respect to the second external surface. The planter may further comprise at least one drain. The planter may further comprise at least one hook located at the bottom of the container. The planter may further comprise a wire covered by concrete. The external surfaces of the container may have an anti-graffiti coating. The first display may be attached to the container with at least one bracket.

According to another aspect of the disclosed technology, there is disclosed a system comprising a first planter and a second planter, wherein controllers of the first planter and the second planter are configured to communicate with each other and generate a display image being split between displays of the first and the second planter.

According to one aspect of the disclosed technology, there is provided a security planter comprising: a container having a bottom and a groove on a first external surface of a first wall of the container, and a first display located in the groove, the first display being attached to the container and operatively connected to a controller located inside the container.

The upper edge of the first wall of the container may be thinner than a first lower wall width of the first wall at a level of a bottom inner surface.

In at least one embodiment, a lower container portion of the container, the lower container portion having a half of the height of the container, weighs more than 68 percent (%) of the total weight of the container. In at least one embodiment, the lower container portion weighs between 70 percent and 77 percent of the total weight of the container. In at least one embodiment, the lower container portion weighs between 71 percent and 75 percent of the total weight of the container.

The first wall of the container may have a first internal surface inside the container, and the first internal surface may have a first step formed on the first internal surface by three internal display surface portions, the first step increasing a width of the first wall in a groove area.

The security planter may further comprise a first internal surface comprising a first internal display surface portion, a second internal display surface portion, a third internal display surface portion, wherein: the first internal display surface portion is approximately parallel to the first external surface, the third internal display surface portion is positioned at a first bottom internal angle, the first bottom internal angle being between the third internal display surface portion and a bottom inner surface of the container, which is larger than an external surface angle between the bottom inner surface and the first external surface; and the second internal display surface portion connecting the first internal display surface portion and the third internal display surface portion. The first bottom internal angle may be between about 110 degrees and about 120 degrees, while the external surface angle is between about 95 degrees and about 105 degrees.

In at least one embodiment, the security planter has a second groove located on a second external surface on a second wall of the container and having a second display located within the second groove, the second display being connected to the controller. A second internal surface of the second wall inside the container may have a second step formed on the second internal surface.

In at least one embodiment, a second wall may have a second external surface and a second internal surface and formed by at least two surface portions, the at least two surface portions forming at least one second upper angle to provide a wider lower wall width of the second wall at a level of a bottom inner surface.

The security planter may further comprise at least one drain. The security planter may further comprise at least one hook located at a bottom of a container hollow extended between a first internal surface and a second internal surface of the container. The security planter may further comprise a steel rebar covered by concrete. The concrete may be a 35 megapascals (MPa) concrete. External surfaces of the container may have an anti-graffiti coating.

According to another aspect of the disclosed technology, there is provided a system comprising a first security planter and a second security planter, and wherein controllers of the first security planter and the second security planter are configured to communicate with each other and generate a display image being split between displays of the first security planter and the second security planter.

According to a further aspect of the disclosed technology, there is provided a method of manufacturing a security planter, the method comprising: welding a rebar; covering the rebar with concrete using a mold to manufacture a container; polishing external surfaces of the container with at least one diamond stone in at least three stages of polishing and then sanding the external surfaces; and after pressure washing and drying the container, applying at least one of a sealer and a coating to the external surfaces of the container. The coating may be an anti-graffiti coating. The polishing with the diamond stone(s) may be performed in four to six stages.

According to a further aspect of the disclosed technology, there is provided a security receptacle comprising: a bottom and four walls forming a hollow with a bottom surface, wherein each wall of at least two walls has an external surface and an internal surface having an upper internal surface angle formed by an upper internal surface portion and a lower internal surface portion, and wherein: the upper internal surface portion is approximately parallel to the external surface, and the upper internal surface angle is between about 150 degrees and about 165 degrees, a bottom internal angle is formed by the lower internal surface and the bottom surface being between about 119 degrees and about 129 degrees, and a lower receptacle portion has a lower portion height of approximately half of a receptacle height of the security receptacle having weight higher than 65% of total weight of the security receptacle.

In at least one embodiment, a security planter comprises a container having a bottom and at least one groove on at least one external surface of the container, and a first display located in the groove, attached to the container and operatively connected to a controller located inside the container. In at least one embodiment, a method of manufacturing of a security planter, the method comprising: welding a rebar; covering the rebar with concrete to manufacture a container; polishing external surfaces of the container with at least one diamond stone in at least three stages of polishing and then sanding the external surfaces; and after pressure washing and drying the container, applying at least one of a sealer and a coating to the external surfaces of the container.

### BRIEF DESCRIPTION OF THE DRAWINGS

Further features and advantages of the present disclosure will become apparent from the following detailed description, taken in combination with the appended drawings, in which:

FIG. 1A is a front perspective view of a security planter, also referred to herein as a plant receptacle, in accordance with at least one embodiment of the present disclosure;

FIG. 1B is a top view of the plant receptacle of FIG. 1A;

FIG. 1C is a cross-sectional view taken along the line A-A of the plant receptacle of FIG. 1B;

FIG. 1D is a front perspective view of the plant receptacle of FIG. 1A with soil and plants;

FIG. 1E is a bottom view of the plant receptacle of FIG. 1A;

FIG. 1F is a cross-sectional view taken along the line B-B of the plant receptacle of FIG. 1B;

FIG. 2A is a front perspective view of a container of a security planter having a display, in accordance with at least one embodiment of the present disclosure;

FIG. 2B is a top view of the security planter having the container of FIG. 2A and the display;

FIG. 2C is a cross-sectional view taken along the line C-C of the security planter having the display of FIG. 2B;

FIG. 2D is an enhanced view of a section H-H FIG. 20;

FIG. 2E illustrates a portion of the container portion illustrated in FIG. 2D;

FIG. 2F illustrates a non-limiting example of the container of FIG. 2C, in accordance with at least one embodiment;

FIG. 3A is a front view of the security planter of FIG. 2A with the display;

FIG. 3B is a bottom view of the container of FIG. 2A;

FIG. 3C is a cross-sectional view taken along the line D-D of the container of FIG. 2A;

FIG. 3D is a top perspective view of the security planter of FIG. 2B illustrating a controller located inside the security planter, in accordance with at least one embodiment of the present disclosure;

FIG. 3E schematically illustrates a back view of the display of FIG. 3A showing brackets, in accordance with at least one embodiment of the present disclosure;

FIG. 3F schematically illustrates a cross-sectional view of the display and a bracket along the line I-I of FIG. 3E;

FIG. 4A illustrates a front perspective view of a two-display container for a two-display security planter having two displays, in accordance with at least one embodiment of the present disclosure;

FIG. 4B is a top view of the two-display security planter with two displays having the two-display container of FIG. 4A;

FIG. 4C is a cross-sectional view taken along the line J-J of the two-display security planter of FIG. 4B;

FIG. 5A schematically illustrates a top view of a system of security planters with displays and controllers, in accordance with at least one embodiment of the present disclosure;

FIG. 5B schematically illustrates a side view of the system of FIG. 5A, in accordance with at least one embodiment of the present disclosure; and

FIG. 6 illustrates various stages of manufacturing of the security planters of FIGS. 1A and 2A, 4A, in accordance with at least one other embodiment.

It will be noted that throughout the appended drawings, like features are identified by like reference numerals.

### DETAILED DESCRIPTION

Various aspects of the present disclosure generally address one or more of the problems of improving security of public spaces while providing an aesthetic and “green” solution while may be aligned with a goal of reducing the human impact on the natural environment.

The present description provides a security planter with and without a display and a method of manufacturing thereof. The planter can be easily installed. The planter as described herein provides additional safety and security protection and may be referred to herein as “security planter” or “safety planter”. For example, the planter as described herein makes possible to stop vehicles, including trucks, on impact and is configured to withstand gun shots (for example, sniper shots). Provided the weight and the size of the planter have values described herein, the form of the planter and the distribution of the weight makes it difficult for the security planter to be overturned or moved due to a car or a truck accident or a pre-meditated collision during an assault. The method of manufacturing of the security planter, coating and treatment of the security planter also help to improve the safety characteristics of the security planter. The finish of the security planter as described herein has a smooth, anti-graffiti finish obtained with the method described herein.

As the security planter is intended to hold soil and plants, the technology as described herein is intended to mitigate the effects of human activity on the environment, especially in the urban areas.

When made from concrete, the security planter as described herein may be referred to as “concrete security planter” or “concrete safety planter”.

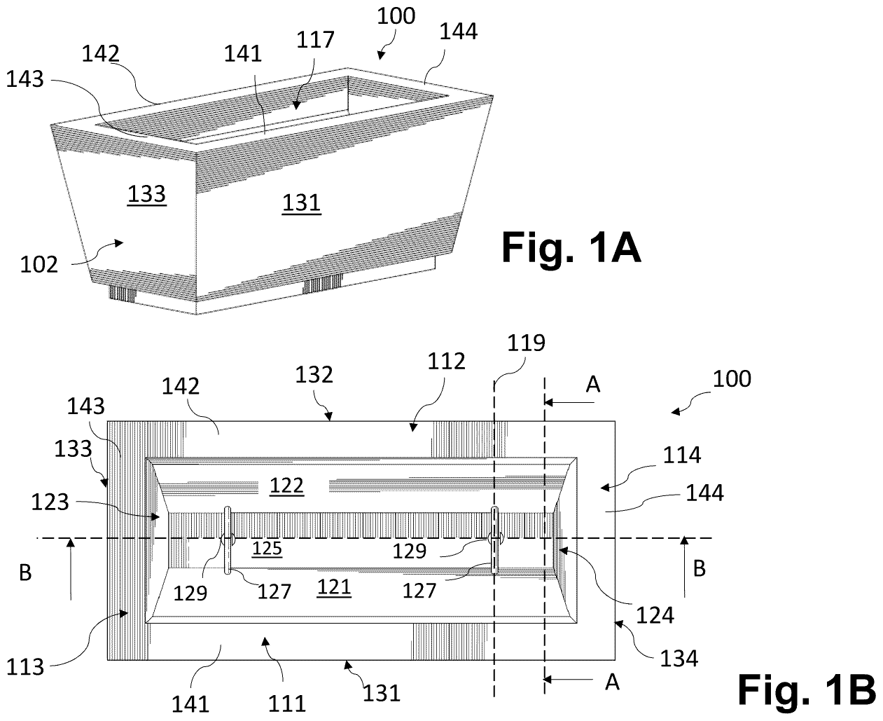

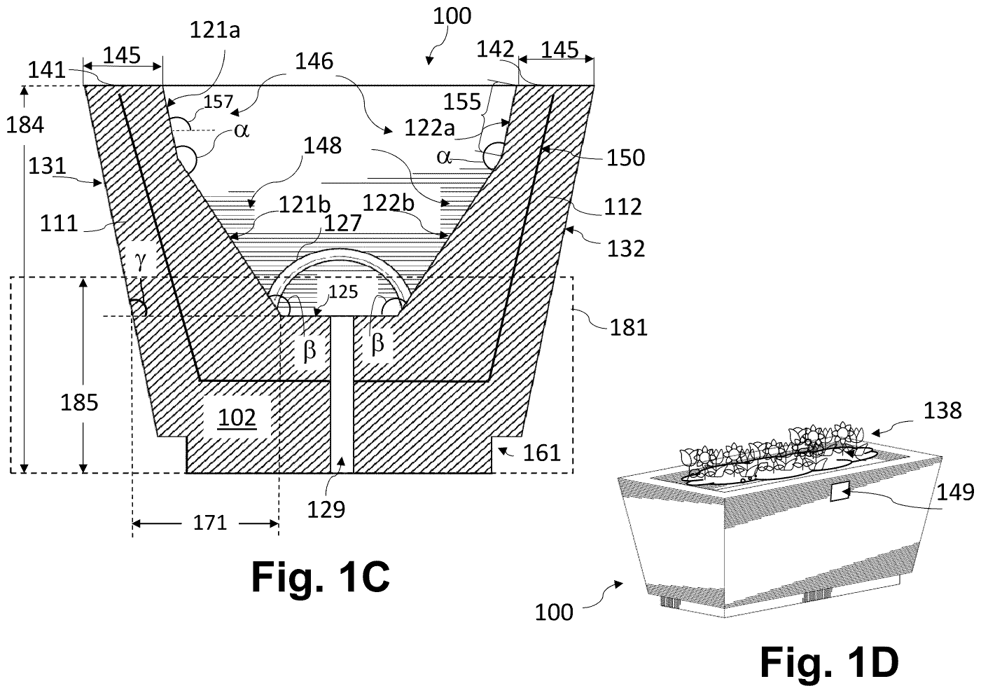

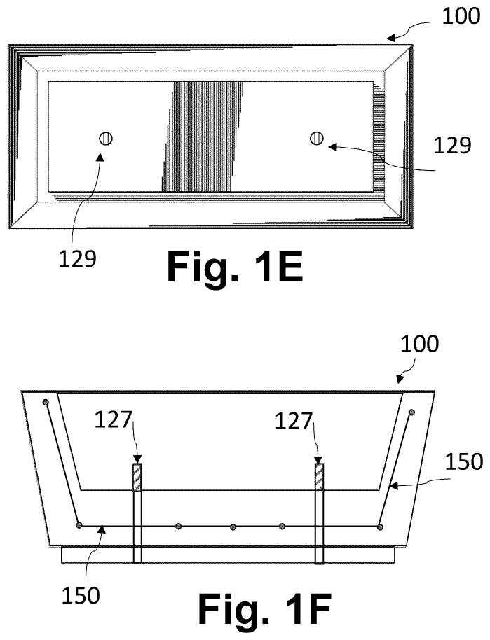

FIGS. 1A-1F illustrate a security planter, referred to herein as a security receptacle 100 (also referred to herein as a “plant receptacle 100” or “receptacle 100”), in accordance with at least one embodiment of the present description. To distinguish from a security planter having a display, the security planter without any display is referred to herein as the “plant receptacle 100”.

The plant receptacle 100 has a bottom 102 and side walls 111, 112, 113, 114 forming a receptacle hollow 117 (also referred to as “cavity 117”) limited by the respective internal surfaces 121, 122, 123, 124 and a bottom surface 125. The walls 111, 112, 113, 114 have flat external surfaces 131, 132, 133, 134, respectfully, and upper edges 141, 142, 143, 144.

In at least one embodiment, the plant receptacle 100 also has at least one hook 127 (FIG. 1C) which may be located at the bottom of the receptacle 100. The hook(s) 127 may be used for picking and displacing (moving) the plant receptacle 100 when the plant receptacle 100 is empty. FIGS. 1B and 1C show that the plant receptacle 100 may have two hooks 127 located at the bottom of the receptacle hollow 117. As illustrated in FIGS. 1B and 1C, the hooks 127 may be extended from one internal surface 121 to another internal surface 122.

When the plant receptacle 100 has been placed (positioned) at the location that it is intended to be used at, the receptacle hollow 117 may be filled with soil and plants 138, as illustrated in FIG. 1D. A label 149 may be attached to the plant receptacle 100, as illustrated in FIG. 1D.

In at least one embodiment, the receptacle 100 may also comprise one or more drains 129 (also seen in FIG. 1E) located at the bottom of the receptacle 100. The drains 129 allow the liquids that may accumulate inside the receptacle hollow 117 to drain outside of the plant receptacle 100. In at least one embodiment, the hooks 127 are located in the imaginary plane 119 illustrated in FIG. 1B. The drain(s) 129 may be located in the same plane 119.

The walls 111, 112 of the receptacle 100 form two sections: an upper section 146 and a lower section 148. In at least one embodiment, at least two internal surfaces 121, 122 of opposite walls 111, 112, respectfully, each has at least two flat surface sections (portions): a first upper internal surface portion 121a and a first lower internal surface portion 121b for the first wall 111, and/or a second upper internal surface portion 122a and a second lower internal surface portion 122b of the second wall 112, as illustrated in FIG. 1C. The first upper internal surface portion 121a and a first lower internal surface portion 121b for the first wall 111, form a “side internal surface angle” α (also referred to herein as an “upper internal angle α” or “upper internal angle alpha”) between them. Similarly, the second upper internal surface portion 122a and a second lower internal surface portion 122b of the second wall 112 form another upper internal angle alpha between them. In at least one embodiment, the plant receptacle 100 has symmetrical opposite walls 111, 112, and the upper internal angle alpha is the same for these two opposite walls 111, 112, as illustrated in FIG. 1C.

The upper internal angle alpha may be, for example, between about 100 and 170 degrees, between about 160 and 170 degrees, between about 151 degrees and about 161 degrees, between about 150 and about 160 degrees, between about 150 and about 165 degrees. Preferably, the upper internal angle alpha may be between about 153 degrees and about 159 degrees. The first and second upper internal surface portions 121a, 122b may be approximately parallel to the first and second external surfaces 131, 132, respectfully.

As illustrated in FIG. 1C, a bottom internal angle beta (β) is formed by the first lower internal surface 121b with the bottom surface 125. An upper angle 157 formed, in the upper section 146, by the first upper internal surface 121a with the bottom surface 125 is different from the bottom internal angle beta formed by the first lower internal surface 121b with the bottom surface 125 in the lower section 148.

As can be seen in FIG. 1C, upper internal angle alpha, which is less than 180 degrees, allows the walls 111, 112 to be thicker than they would be if the walls 111, 112 would have the same thickness as the upper edges 141, 142, respectively. The increase in the thickness of the first wall 111 may be achieved due to the bottom internal angle beta (β) being larger than an external surface angle gamma (γ), which is formed by the external surface 131, 132 and the bottom surface 125 of the receptacle hollow 117.

For example, the bottom internal angle beta (β) may be between about 119 degrees and about 129 degrees, while the external surface angle gamma (γ) may be between about 95 degrees and about 105 degrees. For example, the bottom internal angle beta may be between about 121 degrees and about 127 degrees, while the external surface angle gamma (γ) may be between about 97 degrees and about 103 degrees. For example, the bottom internal angle beta may be approximately 124 degrees, while the external surface angle gamma (γ) may be approximately 100 degrees.

The receptacle upper edge width 145 that is visible to the passers-by, is narrower than the lower wall width 171. For example, the first upper internal surface 121a of the plant receptacle 100 may have upper internal surface depth 155 being approximately equal to, longer than or shorter than the receptacle upper edge width 145, while being at least 30 mm, which may be sufficient to hide the increase in the thickness of the wall 111, 112 under the soil. For example, the receptacle upper edge width 145 may be between 130 millimeters (mm) and 145 mm, in some embodiments between 137 mm and 143 mm. The upper internal surface depth 155 mm may be, for example, between 145 and 160 mm, in some embodiments between 149 mm and 155 mm.

The upper internal angle alpha (α) between the portions of the internal surfaces 121, 122 and therefore different inclination of the first and second lower internal surface portion 121b, 122b with respect to the upper internal surface portions 121a, 122a, allows to increase the thickness of the walls 211, 212, of the receptacle 100, and therefore to increase the weight of the plant receptacle 100, while having the upper edges 141, 142, relatively thin for aesthetic and practical reasons-more soil and plants 138 may be located in the upper section 146 of the plant receptacle 100. In addition, these angled internal surfaces 121, 122 permit (allow) the plant receptacle 100 to be heavier than it looks, while providing enough surface and depth for planting the greens (plants).

The bottom portion 102 of the plant receptacle 100 is also thick to provide additional weight, located in the bottom of the plant receptacle 100 which contributes to the overall stability of the plant receptacle 100.

Due to the thickness of the walls of the plant receptacle 100 and angles, such as the upper internal angle alpha (α) and the bottom internal angle beta (β), their values and their combination described herein, the plant receptacle 100 has most of its weight concentrated in its lower portion: a lower receptacle portion 181 illustrated in FIG. 1C. The lower receptacle portion 181 of the plant receptacle 100 is an imaginary portion of the plant receptacle 100. A lower receptacle portion height 185, which is the height of the lower receptacle portion 181, may be approximately half of the receptacle height 184 of the plant receptacle 100. For example, the lower receptacle portion height 185 of the lower receptacle portion 181 may be half of the receptacle height 184.

To improve stability of the plant receptacle 100, a lower receptacle portion 181 of the plant receptacle 100 has weight higher than 65%, preferably higher than 70% of total weight of the plant receptacle 100, and in at least one embodiment, between 65 percent (%) and 80% of the total weight of the plant receptacle 100. In at least one embodiment, the lower receptacle portion 181 of the plant receptacle 100 weights more than 70%. Preferably, the lower receptacle portion 181 of the plant receptacle 100 may weigh between 70% and 77%, between 71% and 76% of the weight of the plant receptacle 100. Preferably, the lower receptacle portion 181 may weigh approximately 71% to 75% of the total weight of the plant receptacle 100. For example, if the receptacle 100 is 3500 pounds, the lower receptacle portion 181 may weigh 2500 pounds.

In at least one embodiment, the bottom portion 102 of the plant receptacle 100 has a receptacle rim step 161 at the bottom of the walls 111, 112, 113, 114. The receptacle rim step 161 may allow, for example, to pick the plant receptacle 100 from the ground, and to transport the plant receptacle 100.

In at least one embodiment, the security receptacle 100 comprises the bottom 102 and four walls 111, 112, 113, 114 forming the hollow 117 with the bottom surface 125, wherein each wall of at least two walls (for example, the first and second walls 111, 112) has an external surface 131, 132 and an internal surface 121, 122 having the upper internal surface angle alpha formed by the upper internal surface portion 121a, 122a and a lower internal surface portion 121b, 122b. In at least one embodiment, the upper internal surface portion 121a, 122a is approximately parallel to the external surface 131, 132, and the upper internal surface angle alpha is between about 150 degrees and about 165 degrees, the bottom internal angle beta formed by the lower internal surface 121b, 122b and the bottom surface 125 being between about 119 degrees and about 129 degrees, and the lower receptacle portion 181 having the lower portion high 185 of approximately half of the receptacle height 184 of the plant receptacle 100 having weight higher than 65% of total weight of the plant receptacle 100.

The plant receptacle 100 may be made of concrete, such as, for example, and preferably of 35 megapascals (MPa) concrete. For example, the weight of the plant receptacle 100 may be between 1700 et 1800 kg. In a non-limiting example, the weight of the plant receptacle 100 may be 1740 kg.

The way the plant receptacle 100 is made, including the additional unusual concentration of concrete on each side of the plant receptacle 100 closer to the bottom of the plant receptacle 100 (on both sides with respect to the bottom 102), helps keeping the center of gravity of the plant receptacle 100 low with respect to the overall structure of the plant receptacle 100. Such a structure and the low center of gravity improves the stability of the plant receptacle 100 and prevents rolling of the plant receptacle 100 at impact with, for example, a truck.

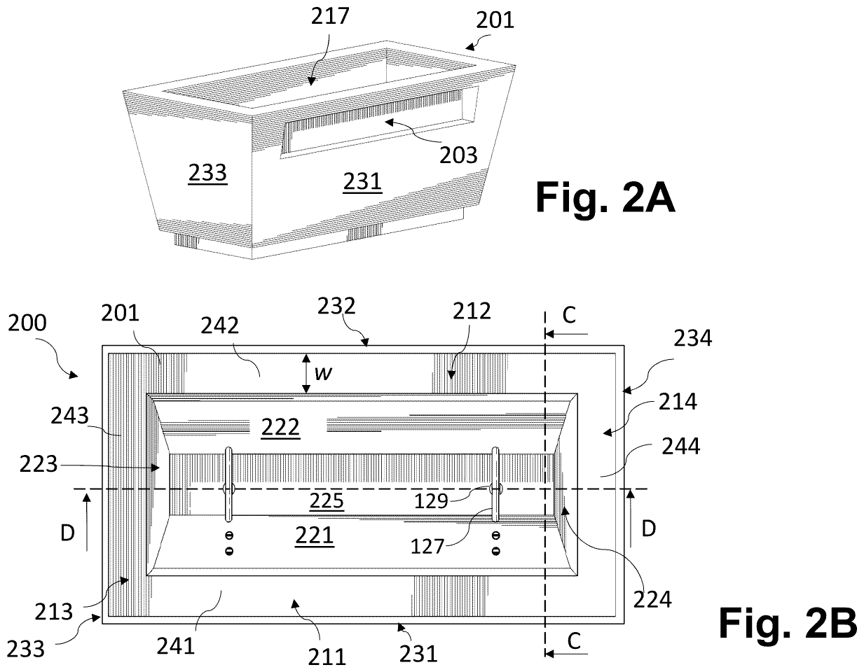

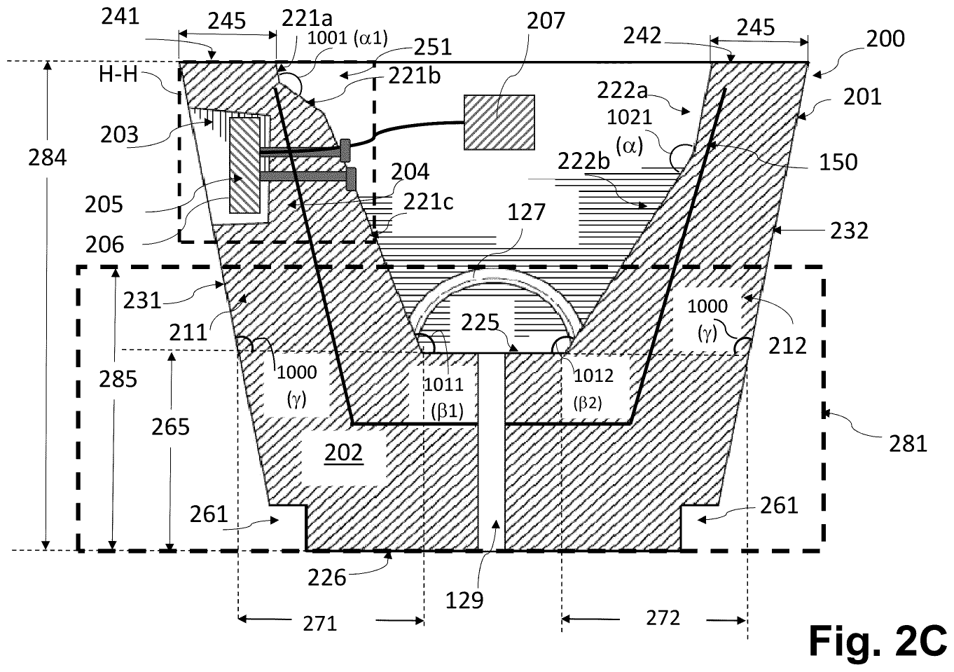

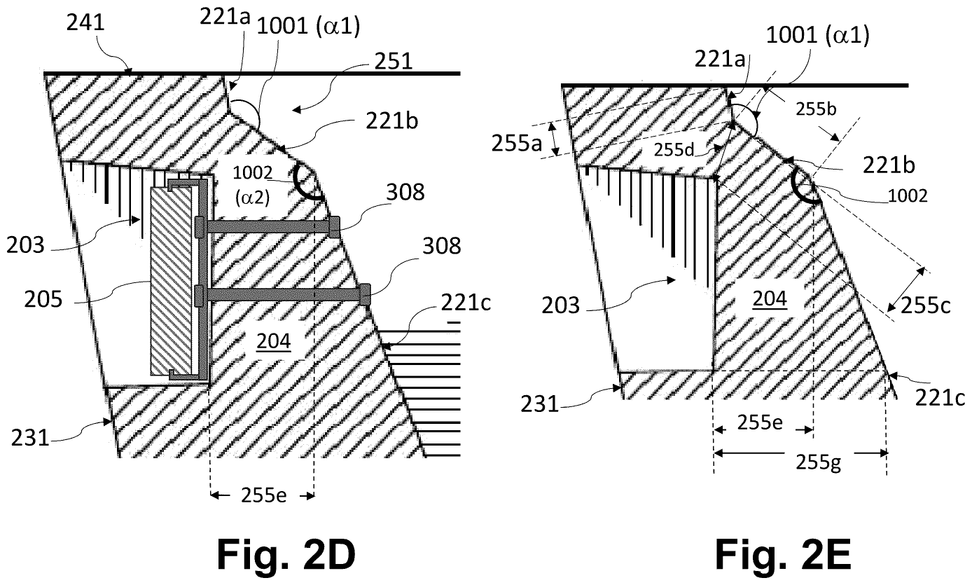

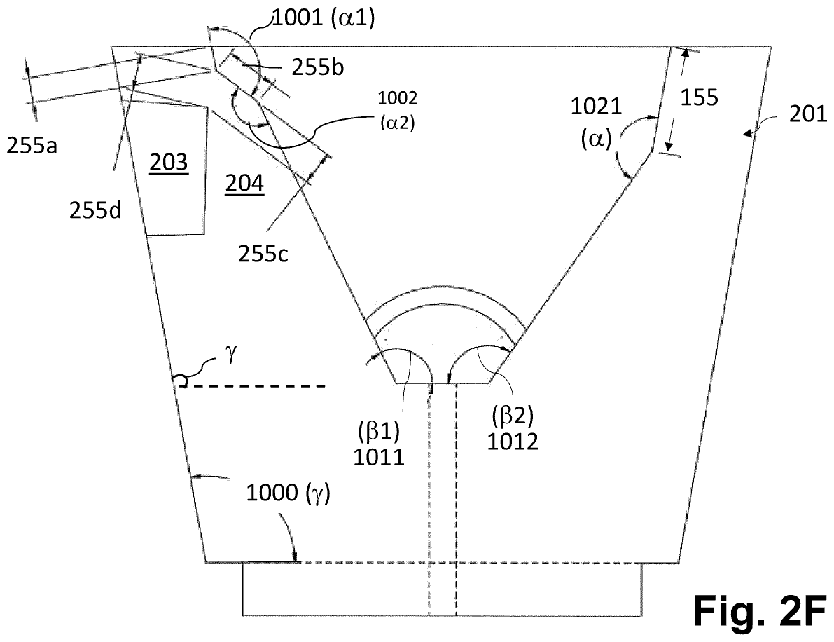

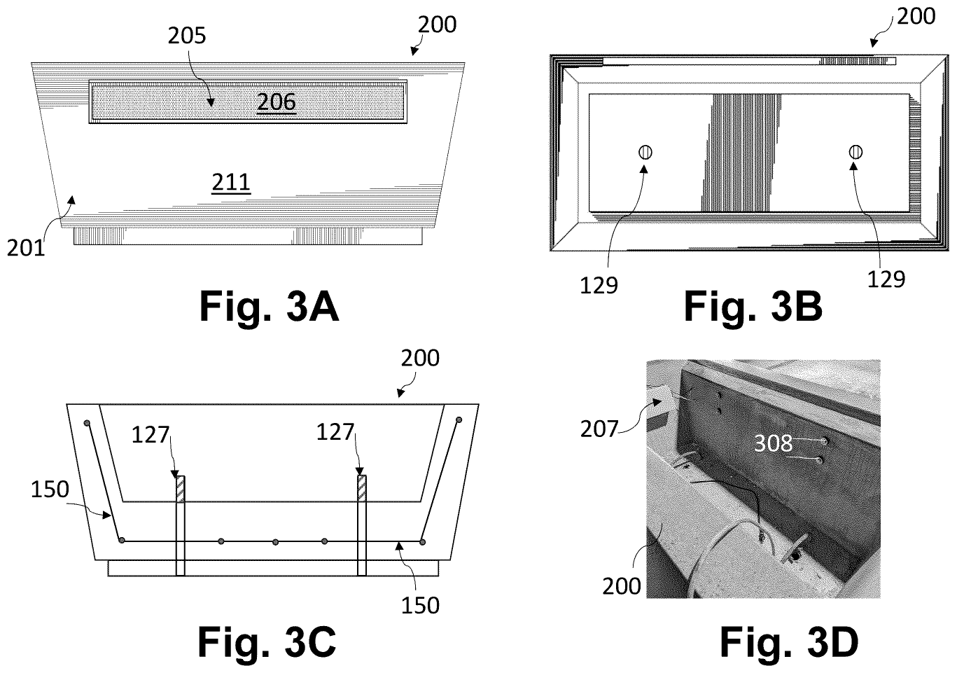

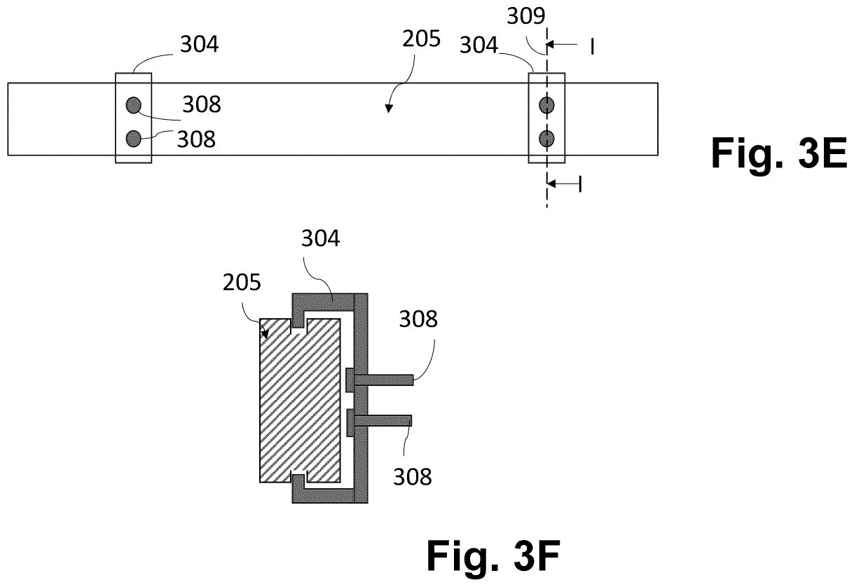

FIGS. 2A-3D illustrate a security planter 200 which comprises a container 201 (which may be also referred to as a “one-display container 201”) and a display 205 attached to the security planter 200, in accordance with at least one embodiment of the present description. As illustrated in FIGS. 2A-2C, the container 201 has a bottom 202 and container side walls 211, 212, 213, 214 forming a container hollow (container cavity) 217 limited by the respective internal surfaces 221, 222, 223, 224 and a bottom inner surface 225. The container walls 211-214 have flat external surfaces 231, 232, 233, 234, respectfully, and upper edges 241, 242, 243, 244 (also referred to herein as “external edges” or “external top edges” 241, 242, 243, 244). The hollow 217 of the security planter 200 may be used for soil and plants as described above with regards to plant receptacle 100.

Similar to the plant receptacle 100 of FIGS. 1A-1F, the security planter 200 has at least one hook 127 located in the bottom of the container hollow 217. The security planter 200 may have at least one drain 129. The security planter may have at least one hook 127 located at the bottom of container 201. Similar to the plant receptacle 100, one or more hooks 127 in the security planter 200 may be located at a bottom of the container 201 and extend between a first internal surface 221 and a second internal surface 222 of the container 201. In other words, in at least one embodiment, at least one hook 127 is located at the bottom of the container hollow 217 and extended between first internal surface 221 and the second internal surface 222 of the container 201. The hooks 127 may be used, for example, for transporting the plant receptacle 100 and the security planter 200.

As can be seen in FIG. 2C, one wall (second wall 212) may have a similar structure (for example, similar angles formed by the internal surfaces 222, 222b between each other and with the bottom inner surface 225) as described above with reference to the walls 111, 112 of the plant receptacle 100 of FIGS. 1A-1F. At least one other wall of the security planter 200, preferably the opposite wall 211, may have a display 205 installed therein as described below.

As illustrated in FIG. 2A, the container 201 has a dent 203 in an external surface of one wall. In at least one embodiment, the container 201 has the dent 203 (which may also be referred to as “a groove 203”) on the first external surface 231 of the first wall 211 of the container 201. The display 205 (also referred to herein as a “first display 205”) is located in the groove 203. The display 205 is attached to the container 201 and is operatively connected to a controller 207 located inside the container 201 as illustrated in FIGS. 20, 3D.

Referring to FIGS. 2A, 3A, the groove 203 may extend along the length of the first wall 211. Preferably, the display 205 is located in the groove 203 on the longer side of the container 201, such as on the first wall 211 or the second wall 212.

In at least one embodiment, the groove 203 for the display 205 may be located on one or both shorter walls 213, 214 of the container 201. In at least one embodiment, the groove 203 is configured to accommodate the display 205 therein. In at least one embodiment, the front surface 206 of the display 205 may be positioned approximately vertically, or at the same plane or approximately the same plane as the external surface 231 of the wall 211 where the display 205 is located. Alternatively, the display 205 and a display front surface 206 may be positioned at another pre-determined angle with the external surface 131. The angle of the display front surface 206 of the display 205 with respect to the ground may be provided such that a message displayed on the display 205 is visible to passers-by.

FIG. 3A illustrates the security planter 200 with the display 205 being attached to the container 201. The display 205 may be a light-emitting diode (LED) based display (also referred to as “LED display”). The display 205 may be adapted to show (present) messages, such as, for example, alert messages.

The display 205 is attached to the container 201 with at least one bracket 304, illustrated in FIGS. 3E and 3F. The brackets 304 are attached to the container 201 with bolts 308. The bracket 304 may be connected to the display 205 in various ways. One of such connections between the bracket 304 and the display 205 is illustrated in FIG. 3F, which illustrates the cross-sectional view of the bracket 304 attached to the display 205 along the line 309 of FIG. 3E.

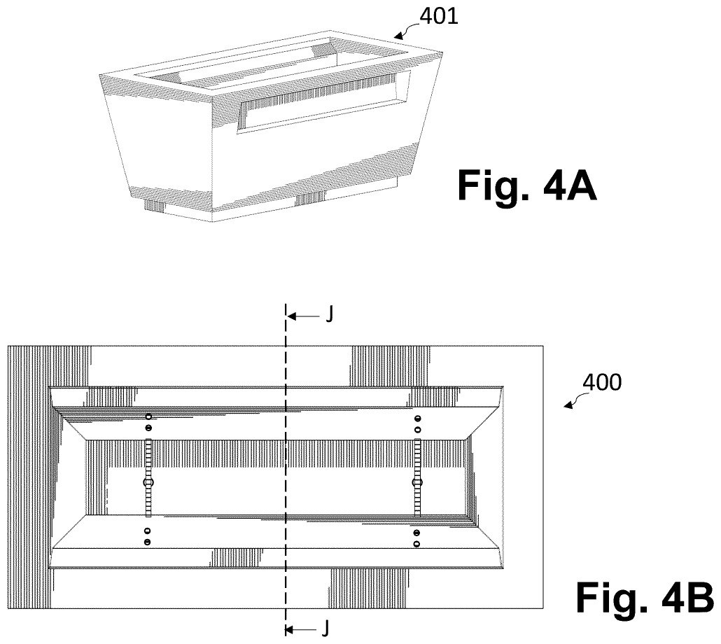

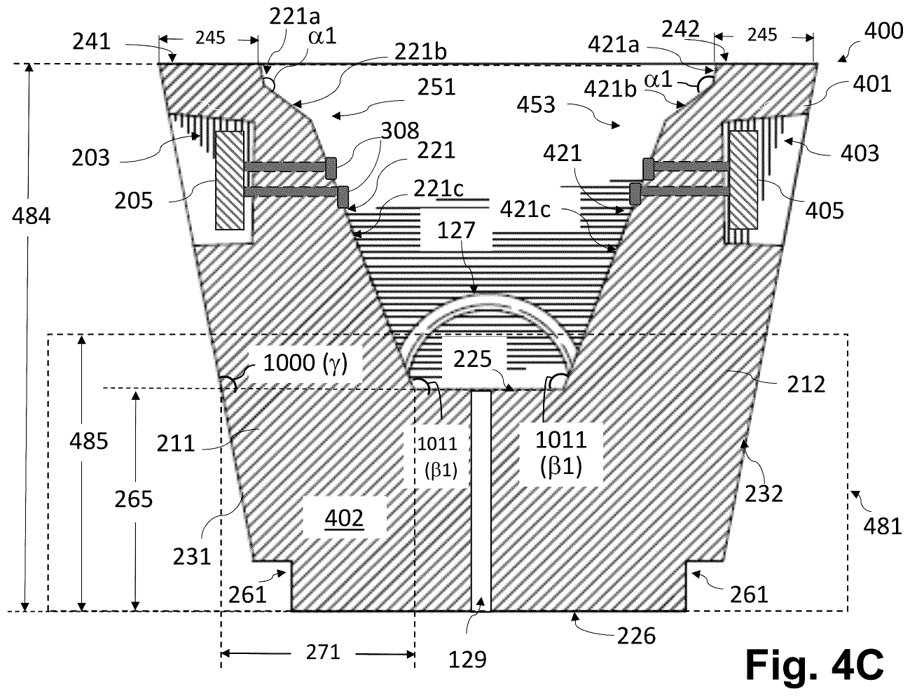

In at least one embodiment, the security planter's container 201 may have two grooves, similar to grooves 203, 403 in a two-display container 401 of a two-display security planter 400 depicted in FIGS. 4A-4C. The wall that has the groove 203, 403 has a groove area 204. The two-display container 401 has, in addition to the first groove 203, a second groove 403 located on a second external surface on the second wall 212 of the two-display container 401. In at least one embodiment, the second display 405 is located within the second groove 405, as illustrated in FIG. 4C. Each one of two displays 205, 405 are located in grooves 203, 403. For example, and preferably, the displays 205, 405 are located on two opposite walls of the container 405.

In at least one embodiment, a security planter's container may have more than two grooves, each groove being on one of the walls of the container. Each display of such security planter may be connected to the controller located inside the security planter. When the wall has the groove to accommodate the display, the structure of that wall needs to be adjusted and reinforced as described herein with respect to the wall(s) 211, 212 with the grooves 203, 405 of the security planters 200, 400 in order to ensure strength of the container and the security planter, especially on an encounter with any external impact, such as, for example, a truck accident or another collision.

In the two-display security planter 400 illustrated in FIGS. 4A-4C, the second display 405 may be also connected to the controller 207, as described for the display 205 of the one-display security planter 200. In the two-display security planter 400 of FIGS. 4A-4C, which has two displays 205, 405, the second display 405 may be similar to the first display 205 and may be attached to the two-display container 401 in a similar manner as the first display 205 is attached to the one-display container 201.

The security planter 400 may also have one or more drains 129 and one or more hooks 127 as described herein with reference to the one-display security planter 200.

FIG. 2C illustrates a lower container portion 281 of the container 201 which is an imaginary portion of the container 201 (also referred to herein as a “lower one-display planter portion 201”) that has a half-height of the one-display container 201. For example, a lower portion height 285 of the lower container portion 281 may be a half of the one-display container height 284.

Similarly, FIG. 4C illustrates the two-display container 401 which has a lower two-display planter portion 481 which is an imaginary portion of the two-display container 401 that has a half-height of the two-display container 401. For example, a lower portion height 485 of the lower two-display planter portion 481 may be a half of the two-display container height 484.

To improve stability of the one-display security planter 200, the one-display lower container portion 281 of the container 201 has weight of between 65 percent (%) and 80% of the total weight of the container 201. In at least one embodiment, the one-display lower container portion 281 weights more than 70% of the total weight of the container 201. In at least one embodiment, the lower container portion 281 of the container 201, the lower container portion 281 having a half of the height of the container 201, weighs more than 65 percent of the total weight of the container 201, preferably more than 68% of the total weight of the container 201. In at least one embodiment, the one-display lower container portion 281 of the one-display security planter 200 may weigh between 70% and 76%, between 70% and 77% of the total weight of the one-display container 201. Preferably, the one-display lower container portion 281 may weigh approximately between 71% and 76% of the total weight of the container 201. For example, the one-display container 201 may weigh 3500 pounds (approximately 1587.57 kilogram), and the one-display lower container portion 281 may weigh 2500 pounds (approximately 1133.98 kilogram).

Similarly, to improve stability of the two-display security planter 400, the lower container portion 481 of the two-display container 401 has weight of between 65 percent (%) and 80% of the total weight of the two-display container 401. In at least one embodiment, the lower container portion 481 of the security planter 400 weighs more than 70% of the total weight of the two-display container 401. In at least one embodiment, the lower container portion 481 weighs more than 65 percent of the total weight of the two-display container 401, preferably more than 68% of the total weight of the two-display container 401. The two-display lower container portion 481 of the two-display security planter 400 may weigh between 70% and 76%, between 70% and 77% of the total weight of the two-display container 401. Preferably, the two-display lower container portion 481 may weigh approximately between 71% and 76% of the total weight of the two-display container 401. For example, if the two-display container 401 is 3500 pounds, the two-display lower container portion 481 may weigh 2500 pounds.

Such advantageous proportion of the weight of the lower container portions 281,481 to the total weight of the corresponding container 201, 401 is due to thicker bottom portion 202 of the container, as well as thickening of the walls 211, 212 of the container 201, 401 towards the bottom 202, 402 as described herein.

In order to accommodate the display 205, 405 inside the wall(s), but not to reduce the safety and security features of the container 201, 401 and therefore the safety and security of the security planter 200, 400, the wall(s) bearing the display(s) 205, 405 is (are) reinforced while the upper edges of wall, including the first wall 211 bearing the display 205, have approximately the same upper edge width 245 for all four walls 211, 212, 213, 214 of the security planter 200, 400. The reinforcing of the wall(s) is achieved by making those wall(s) thicker in the groove area 204.

The wall (for example, the first wall 211 in the one-display container 201 of FIG. 2C and also the second wall 212 in the two-display container 401 of FIG. 4C) that has the groove 203, 403, is made thicker, with the width of that wall increasing towards the bottom of the container 201.

A groove area width 255g (FIG. 2E) of the groove area 204 of the wall 211 between the groove 203 and a portion of the first internal surface 221 of the one-display container 201 may be approximately the same as or wider than the upper edge width 245 of the upper edge 241 of that first wall 211. Similarly, in the two-display container 401, the groove area widths 255g of the groove areas 204 of both walls 211, 212 may be approximately the same width as or wider than the upper edge width 245 of the corresponding wall 211, 212. In some embodiments, the groove area width 255g may be between 90% and 110% of the upper edge width 245 of the container 201, 401. This allows the wall(s) 211, 212 to be thick and strong even around the groove(s) 203 in the security planters 200, 400.

Such enhancement of the thickness of the wall 211 in the groove area 204 helps to reinforce the wall 211 in the groove area 204 and to compensate for the presence of the groove 203 in the corresponding first wall 211, resulting in improving of strength, solidity and endurance of the security planter 200, 400 thus improving reliability for the security purposes.

Such configuration of the wall(s) bearing the display(s) 205, 405 allows the upper edge width 245 of the upper edges 241-244, which may be visible to the passers-by, of the security planter 200, 400 to be, for example, the same for all the walls 211, 212, 213, 214, and therefore the soil and the plants may hide, from the passers-by, the fact that one or more walls (for example, the first wall 211 and/or other walls 212, 213, 214) of the security planter 200, 400 are (or may be) reinforced.

Due to such reinforcement of the wall 211, the wall 211 is not weakened by the groove 203. The reinforcement of the wall(s) adds to the stability and strength of the security planter 200 and improves the protection provided by the security planter 200, while the upper edge width 245 of the upper edges 241, 242, 243, 244 do not show to the passers-by that the security planter 200 is reinforced. In a non-limiting example, the upper edge width 245 of the upper edges 241, 242, 243, 244 may be between 10 and 20 inches.

As illustrated in FIG. 2C, thickening of the first wall 203 may be provided by at least one step on the first internal surface 221. Referring to FIG. 2C, in at least one embodiment, the first internal surface 221 of the first wall 211 of the container 201 has a first step 251 configured to thicken (increase) the width of the first wall 211 around the groove area 204 and along the first wall 211 while keeping a narrower external top edge 241 (the same upper edge width 245 as the other top edges 242, 243, 244 of the security planter 200) of the container wall 211. As discussed above, such thickening of the wall 211 of the container 201 in the first groove area 204 is provided to reinforce the first wall 211 and the container 201 around the groove area 204. FIG. 2D is an enhanced view of a section H-H FIG. 2C. FIG. 2E illustrates a corresponding portion of the container 201 of FIG. 2D. FIG. 2F further illustrates the container 201 of FIG. 2C, in accordance with at least one embodiment of the present disclosure.

As illustrated in FIGS. 2B, 2C and 2D, the first internal surface 221 may have at least two flat surfaces (surface portions) providing different angles with respect to the first external surface. Preferably, the first internal surface 221 may have three flat internal display surface portions 221a, 221b, 221c. The three internal display surface portions 221a, 221b, 221c comprise: a first internal display surface portion 221a, a third internal display surface portion 221b, and a third internal display surface portion 221c. These three internal display surface portions 221a, 221b, 221c, each being preferably a flat surface portion, form the first step 251 by two bends on the first internal surface 221 which permit thicken the first wall 211 and therefore to reinforce the container 201 while providing the niche (recess) by the groove 203 for the display 205.

In at least one embodiment, the first internal display surface 221 is approximately parallel to the first external surface 231. In at least one embodiment, the second and third internal display surface portions 221b and 221c have different angles with respect to the first external surface 231. An upper internal groove angle 1001 (which may be also referred to as an “upper internal groove angle alpha1 (α1)”) is formed by the upper (first) internal display surface portion 221a and a middle (second) internal display surface portion 221b (FIG. 2C). A groove area angle 1002 is formed by the middle internal display surface portion 221b and the third (lower) internal display surface portion 221b (FIGS. 2D, 2E). A groove wall bottom internal angle 1011 (also may be referred to as a “groove wall bottom internal angle beta1 (β1)”) is formed between the third internal display surface portion 221c and the bottom inner surface 225 of the container 201 (FIGS. 2C, 2F). An external surface angle gamma 1000 (γ) is an angle between the external surface 231 and the bottom surface 225 (or the bottom outer surface 226) of the container 201.

In at least one embodiment, the first internal display surface portion 221a is approximately parallel to the first external surface 231, the third internal display surface portion 221a is positioned at the groove wall bottom internal angle 1011, which is larger than an external surface angle gamma 1000 (γ) formed between the first external surface 231 and the bottom inner surface 225; and the second internal display surface portion 221b connects the first internal display surface portion 221a and the third internal display surface portion 221c.

The container 201 has the structure that allows having most of the weight in the one-display lower container portion 281 while providing enough thickness in the upper portion of the container 201, around the groove area 204, and the container 201 has the strength to sustain any impact, such as, for example, an encounter with a vehicle.

In at least one embodiment, to increase the thickness of the wall 211, the groove wall bottom internal angle 1011 (β1) is larger than the external surface angle gamma 1000 (γ). In at least one embodiment, the groove wall bottom internal angle 1011 (β1) may be larger than the external surface angle gamma 1000 (γ), for example, by between about 10 degrees to about 20 degrees. For example, the groove wall bottom internal angle 1011 (β1) may be between about 110 and about 120 degrees, while the external surface angle gamma 1000 (γ) may be between about 95 and about 105 degrees. Preferably, in at least one embodiment, the groove wall bottom internal angle 1011 (β1) is between about 112 and about 118 degrees, preferably approximately 115 degrees, and the external surface angle gamma 1000 (γ) is between about 97 degrees and about 103 degrees, preferably approximately 100 degrees.

In at least one embodiment, the upper internal groove angle 1001 is between about 135 degrees and about 141 degrees, preferably approximately 138 degrees. In at least one embodiment, the groove area angle 1002 between the second internal display surface portion 221b and the third internal display surface portion 221c may be between 148 and 158 degrees, between about 150 and about 156 degrees, preferably approximately 153 degrees.

FIG. 2F illustrates a non-limiting example of the container 201, in accordance with at least one embodiment of the present disclosure. For example, the first internal surface depth 255a may be, for example, at least 30 mm, preferably at least 33 mm. Such depth of the first internal display surface portion 221a helps hiding, from the passers-by, the fact that the wall 211 of the container 201 is thicker than the first upper edge 241 and other upper edges 242, 243, 244. In some embodiments, the first internal surface depth 255a may be, for example between 33 mm and 40 mm.

In at least one embodiment, a second internal surface depth 255b may be, for example, between 65 mm and 76 mm, between 69 mm and 75 mm. For example, the second internal surface depth 255b may be, for example, 72 mm.

In at least one embodiment, a second surface distance 255c between the groove 203 and the second internal display surface portion 221b is more than 44 mm, for example, between 44 mm and 54 mm. In at least one embodiment, preferably, the second surface distance 255c between the groove 203 and the second internal display surface portion 221b may be between 46 mm and 52 mm. The second surface distance 255c provides minimal distance between the upper corner of the groove 203 and the second (middle) internal display surface portion 221b. A groove-first-angle distance 255d between the upper corner of the groove 203 and the upper internal groove angle 1001 may be at least 45 mm, for example, between 48 mm and 58 mm. Preferably, the groove-first-angle distance 255d is more than 48 mm.

A combination of minimal values of the second surface distance 255c and the groove-first-angle distance 255d ensures the solidity of the corresponding wall with the groove 203 and therefore the solidity and the durability of the security planter 200, 400. Preferably, to ensure the solidity and strength of the security planter 200, 400, the second surface distance 255c is more than 44 mm, while the groove-first-angle distance 255d is more than 48 mm when the concrete as described herein is used. A groove-second angle 255e may be determined based on the minimal values of the second surface distance 255c and the groove-first-angle distance 255d.

For example, in the security planter 200, 400 with one or two displays, the wall with the groove 203 may have the first internal surface depth 255a being between 31 and 41 mm, preferably between 33 mm and 39 mm; the second internal surface depth 255b may be between 67 mm and 77 mm, preferably between 69 mm and 75 mm; the second surface distance 255c may be for example between 44 mm and 54 mm, preferably between 46 mm and 52 mm; and a groove-first-angle distance 255d between the groove 203 and the upper internal groove angle 1001 may be, for example, between 48 mm and 58 mm, preferably between 50 mm and 56 mm.

For example, in the security planter 200, 400 with one or two displays, the wall with the groove 203 may have: the first internal surface depth 255a may be approximately 36 mm; the second internal surface depth 255b may be approximately 72 mm; the second surface distance 255c may be for example approximately 49 mm; and a groove-first-angle distance 255d may be, for example, approximately 53 mm. For example, the external surface angle gamma 1000 may be approximately 100 degrees, the groove wall bottom internal angle 1011 may be approximately 115 degrees, the upper internal groove angle 1001 may be approximately 138 degrees, and the groove area angle 1002 may be approximately 153 degrees. For example, in the security planter 200 with one display, the second wall 212 without the groove (which may be referred to as a “groove-less wall”) may have the upper internal surface depth 155 of approximately 152 mm. For example, for the second wall 212 without the groove, the upper angle 1021 may be approximately 156 degrees, the second bottom internal angle 1012 may be approximately 124 degrees.

In at least one embodiment, upper edge width 245 of the container 201, that is visible to the passers-by, is narrower than the container lower wall width 271. In other words, the upper edge 241 of the first wall 211 of the container 201 is thinner than a first lower wall width 271 of the first wall 211 at a level of the bottom inner surface 225.

A second wall 212 of the security planter 200, which is an opposite wall to the display (first) wall 211, does not have any groove for any display. As illustrated in FIG. 2C, the second wall 212 may have two second internal surface portions 222a, 222b forming an upper angle 1021 which may be also referred to as an upper angle alpha (α) as in the plant receptacle 100 which does not have grooves, discussed herein, where the upper angle 1021 is less than 180 degrees. For example, the upper angle 1021 may be between about 151 degrees and about 161 degrees, preferably between about 153 degrees and about 159 degrees. For example, the upper angle 1021 may be approximately 156 degrees.

A second bottom internal angle 1012 (beta2, β2) is the angle formed by the lower second internal surface 222b (of the second internal surface 222 of the second wall 212) with the bottom inner surface 225. The second bottom internal angle 1012 in the one-display security planter 200 may be the same as the angle beta (β) in the plant receptacle 100. The increase in the thickness of the second wall 212 may be thus achieved due to the second bottom internal angle 1012 being larger than the external surface angle gamma 1000 as illustrated in FIG. 2C. For example, the second bottom internal angle 1012 may be between 119 about degrees and about 129 degrees, preferably between about 121 degrees and about 127 degrees. For example, the second bottom internal angle 1012 may be larger than the external surface angle gamma 1000 by more than about 20 degrees.

For example, the second bottom internal angle 1012 may be between about 119 degrees and about 129 degrees, while the external surface angle gamma 1000 may be between about 95 and about 105 degrees. For example, the second bottom internal angle 1012 may be between about 121 degrees and about 127 degrees, while the external surface angle gamma 1000 may be between about 97 and about 103 degrees. For example, the second bottom internal angle 1012 may be approximately 124 degrees, while the external surface angle gamma 1000 may be approximately 100 degrees.

The combination of the second bottom internal angle 1012 and the external surface angle gamma 1000 permits increasing the width of the wall 212 towards the bottom of the container 201, while providing sufficient space for the soil and plants. In at least one embodiment, the second wall 212 has a second external surface 232 and the second internal surface 222, the second internal surface 222 being formed by at least two surface portions 222a, 222b forming at least one upper angle 1021 that is less than 170 degrees, and may be less than 160 degrees, to provide a wider lower wall width 272 of the second wall 212 at (in other words, to widen the wall 212) a level of the bottom inner surface 225, where the upper internal surface portion 222a is parallel to the flat external surfaces 232.

Thus, in the container 201 of the security planter 200, the second upper edge 242 has approximately the same upper edge width 245 as the first upper edges 241, while the second wall 212 is wider towards the bottom of the hollow 217. For example, to provide a perception of thin walls of the container 201 to the passers-by, the upper portion of the second wall 212, which extends between the second upper edge 242 and the groove area angle 1002, may be, for example, between 5 and 10 inches (127 mm and 254 mm), between 147 mm and 157 mm, between 149 mm and 155 mm.

For a non-limiting example, the second wall 211 of the container 201 of FIG. 2F, the upper internal surface depth 155 may be between 147 mm and 157 mm, preferably between 149 mm and 155 mm.

In the embodiment of the security planter 400 having two displays, as illustrated in FIGS. 4A-4C, both walls 211, 213, each bearing the display 205, 405, have the steps on the internal surfaces 221, 421 of the container 401: the first step 251 on the first internal surface 221 of the first wall 211 and the second step 453 on the second internal surface 421 of the second wall 212. The first and second steps 251, 453 increase the width of the walls 211, 212 of the security planter 400. The second internal surface 421 of the second wall 212 as illustrated in FIG. 4C may have the second step 453 configured to thicken (increase the width of) the second wall 212 around a groove area 204 and along the second wall 212 while keeping a narrower external edge 242 of the second container wall 212. Thus, the second internal surface 421 may also have three surfaces 421a, 421b, 421c providing different angles with respect to the second external surface, as discussed with respect to the first wall 211 having the groove 203 for the display 205.

As in the one-display security planter 200, the purpose of these steps 251, 453 on the internal walls of the two-display security planter 400 is to reinforce the wall(s) where the groove(s) 203, 403 for the display 205, 405 is (are) provided. For both security planters 200, 400, by increasing the groove wall bottom internal angle(s) 1011 (β1) formed by the lower internal display surface portion(s) 221c, 421c with the bottom inner surface 225 with respect to an external surface angle gamma 1000, the walls 211, 212 may be made thicker and therefore the security planter(s) 200, 400 may be made heavier and more stable. For example, and as discussed above, the groove wall bottom internal angle 1011 may be larger than an external surface angle gamma 1000, for example, by about 10 degrees to about 20 degrees. For example, the groove wall bottom internal angle 1011 may be larger than an external surface angle gamma 1000 by about 12 degrees to about 18 degrees. For example, the groove wall bottom internal angle 1011 may be approximately 115 degrees while the external surface angle gamma 1000 may be approximately 100 degrees.

For example, the width of the bottom inner surface 225 of security planter 400 may be 5 to 10 inches (for example, for a security planter 400 having a size of 4 feet by 4 feet). In at least one embodiment, parameters of the second wall 212 of the two-display security planter 400, such as, the widths and distances related to the second step 453 may be the same as the first step 251 on the first wall 211 as discussed above.

The bottom 202 of the two-display security planter 400 may be similar to the bottom 202 discussed above for one-display security planter 200. In at least one embodiment, the bottom 202 of the planter 200, 400 has a rim step 261 at the bottom of the walls 211, 212, 213, 214. The rim step 261 may allow, for example, to pick from the ground and transport the security planter 200.

To increase the weight of the security planter 200, 400, in some embodiments, the bottom 202 of the container 201, 401 may be thicker than, for example, the first wall 211. In other words, preferably, a bottom thickness 265 of the bottom 202 (which may be calculated as a distance between the bottom inner surface 225 and the bottom outer surface 226) may be larger (thicker) than a first lower wall width 271 of the first wall 211 at the level of the bottom inner surface 225.

In some embodiments of the receptacle 100 and security planters 200, 400, angles alpha (α) and beta (β), upper internal groove angle 1001, groove area angle 1002, groove wall bottom internal angle 1011, and second bottom internal angle 1012 other angles of the receptacle 100 and security planters 200 may be formed with continuous smooth bends at the intersection of the corresponding internal surfaces. In other words, the angles of the receptacle 100 and security planters 200, 400 may be smooth. In the preferred embodiments, the angles alpha (α) and beta (β), upper internal groove angle 1001, groove area angle 1002, groove wall bottom internal angle 1011, and second bottom internal angle 1012, as well as other angles of the receptacle 100 and the security planters 200, 400 illustrated in the drawings, have sharp bends provided at intersections of flat surfaces or portions of the surfaces. Such sharp bends at various angles of the receptacle 100 and security planters 200, 400 help to ensure strength, stability and endurance of the receptacle 100 and security planters 200, 400, thus improving reliability for the security purposes.

For example, the container 201, 401 of the security planter 200, 400 may be made of concrete, such as, for example, and preferably of 35 MPa concrete. In at least one embodiment, similar to the plant receptacle 100, the container 201, 401 comprises a rebar 150 (in other words, a reinforcing bar, also may be referred to as a “wire frame”) that is covered by concrete during the manufacturing. Preferably, the rebar 150 is a steel rebar. For example, the weight of the security planter 200,400 may be approximately 3500 pounds (1587.6 kilograms). The weight of the security planter 200, 400 with the soil and plants may be approximately 4000 pounds (1814.4 kilograms). For a non-limiting example, the plant receptacle 100 (described above) or the security planter 200, 400 may have the width of approximately 76 cm (2.5 feet), or 91.4 cm (3 feet) and the length of approximately 121.9 cm (4 feet). For a non-limiting example, the security planter may be 4 feet by 4 feet or 2.5 feet by 4 feet. The bottom of the receptacle 100 or the security planter 100, 200, 400 may have a rectangular shape, and, in some embodiments, square shape. The height of the plant receptacle 100 or the security planter 200, 400 may be, for a non-limiting example, approximately 80 cm (for example, 81 cm) or more (higher) to prevent a truck or another vehicle to overrun the receptacle 100 or the security planter 200, 400 on the impact.

Similar to the plant receptacle 100 described above, the way the security planter 200, 400 is made, including the reinforcement and thickening of the walls and thickening of the bottom 202 by additional unusual concentration of concrete on each side wall and closer to the bottom of the container 201, 401 of the security planter 200, 400 (on both sides with respect to the bottom), helps keeping the center of gravity of the security planter 200, 400 low with respect to the overall structure of the security planter 200, 400. Such a structure and the low center of gravity improves the stability of the security planter 200, 400 and prevents rolling of the security planter 200, 400 at impact with, for example, a truck or another vehicle.

FIG. 3D is a top perspective view of the security planter 200 of FIG. 2B illustrating the controller 207 located inside the security planter 200, in accordance with at least one embodiment of the present disclosure. Similar controller 207 may be located inside a two-display security planter 400 of FIG. 4C. The controller 207 is connected to a power outlet and to one or two displays 205, 405. The controller 207 is configured to operate the display(s) 205, 405 and to communicate with an electronic device (for example, a user device that operates the controller and transmits a message to be displayed on the controller 207) and/or a server. In at least one embodiment, the controller 207 may operate wirelessly and therefore communicate wirelessly with the electronic device(s) and/or server(s).

In some embodiments, the controller 207 may be connected to a solar panel located on (or attached to) the container.

The container 201, 401 may be manufactured, with the external surfaces of the container 201, 401 having a coating and being enforced, using the following steps.

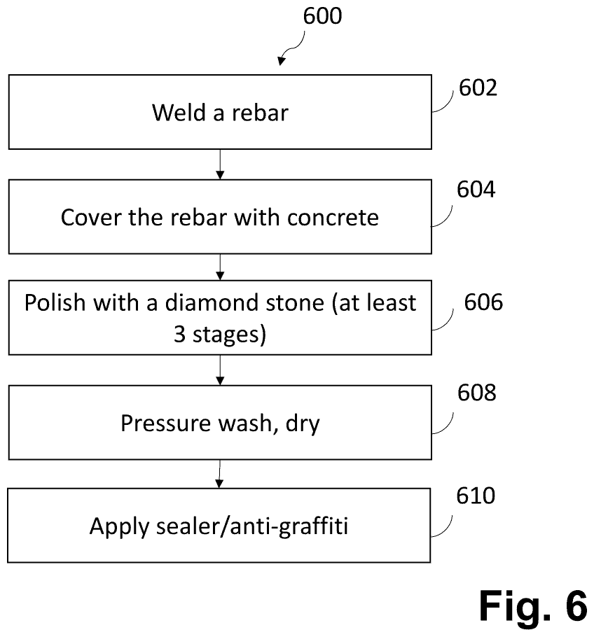

FIG. 6 illustrates a method 600 of manufacturing the plant receptacle 100 or the security planter 200, 400, in accordance with at least one embodiment of the present disclosure. The plant receptacle 100 and the security planter 200, 400 may be manufactured using the rebar 150, illustrated in FIGS. 10, 1F, 20, 3C. At step 602, the rebar 150 is welded together.

The rebar 150 is then covered by concrete (step 604). The groove(s) 203, 403 in one and two-display security planters 200, 400 may be manufactured using a mold. In at least one embodiment, the mold has at least one dent for at least one groove 203, 403 for the at least one display 205, 405. Thus, to manufacture the one and two-display security planters 200, 400, the rebar 150 is covered by concrete using the mold which provides for manufacturing the groove(s) 203, 403. After removing the groove mold from the groove(s) 203, 403, the groove(s) 203, 403 may be painted and the bolts 308 may be installed for the attachment of the brackets of the display(s) 205, 405. The plant receptacle 100 as described herein is manufactured without a groove.

The method 600 of manufacturing of the receptacle 100 and the security planter 200, 400 illustrated in FIG. 6 may comprise the following steps related to finishing of the surfaces (for example, at least the external surfaces 231, 232, 233, 234) of the concrete structure of the container 201, 401. The external surfaces of the container 201, 401 or the receptacle 100 may be manufactured/finished using the method as described herein.

At step 606, after the concrete has dried up, external surfaces of the container are polished with at least one diamond stone in at least three stages of polishing. In other words, the diamond polishing is applied (performed) to the external surfaces of receptacle 100 or the container 201, 401 with a diamond stone (diamond stones), in at least three stages of polishing. This allows reinforcing the surface of the container 201, 401. After polishing the external surfaces, the external surfaces may be sanded. Sandblasting may be applied.

At step 608, the surfaces of the receptacle 100 or the container 201, 401 are pressure-washed and dried. At step 610, after pressure washing and drying the receptacle 100 or the container 201, 401, a sealer and/or a coating is applied to the external surfaces of the receptacle 100 or the container 201, 401. These steps help to close the pores on the surfaces of the container 201, 401 and enforce the container 201, 401. The coating may be an anti-graffiti coating. The external surfaces of the receptacle 100 and container 201, 401 may have the anti-graffiti coating.

Preferably, the polishing with the diamond stone(s) is performed in at least four stages. In at least one embodiment, the polishing with the diamond stone(s) may be performed in 4 to 8 stages, in 4 to 7 stages, preferably in 4 to 6 stages. A layer of a sealer may be applied after executing all the stages of polishing with the diamond stone(s), washing and drying the surfaces.

Such a treatment of the external surfaces 131-134, 231-234, and especially at least 3 stages or at least 4 stages of the diamond polish, preferably four to six stages, helps to harden the external surfaces of the receptacle 100 or the container 201, 401. In addition, such treatment of the external surfaces helps reducing the sticking of various particles to these external surfaces, including pollutant(s) or graffiti, and facilitating maintenance (such as, for example, washing and cleaning) of the receptacle 100 or the container 201, 401 of security planter 200, 400.

In at least one embodiment, the method 600 of manufacturing a security planter comprises welding a rebar; covering the rebar with concrete using a mold to manufacture a container; polishing external surfaces of the container with at least one diamond stone in at least three stages of polishing and then sanding the external surfaces; and after pressure washing and drying the container, applying at least one of a sealer and a coating to the external surfaces of the container. The polishing with the diamond may be performed in four to six stages.

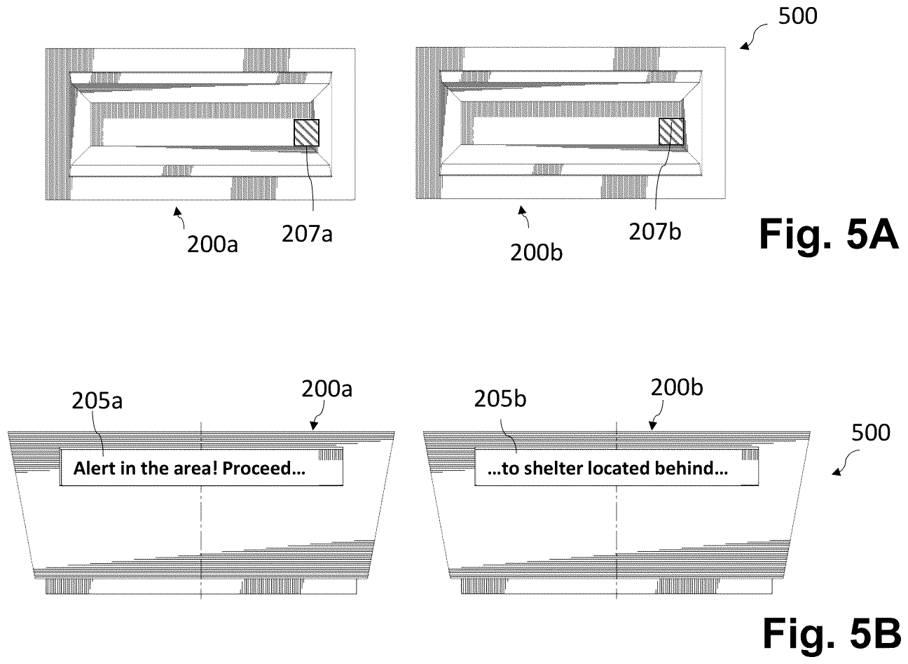

FIGS. 5A and 5B schematically illustrate a system of security planters with displays and controllers, in accordance with at least one embodiment of the present disclosure.

In at least one embodiment, the security planter 200, 400 (referred to herein as a “first planter 200a”) with one or two displays 205, 405 may be used together with another planter (second security planter 200b in FIGS. 5A, 5B) having one or two displays 205, 405. In such a system 500, schematically illustrated in FIG. 5A, a first controller 207a and second controller 207b of the first planter and the second planter are configured to communicate with each other and generate a display image being split between displays 205a, 205b of the first and the second security planter 200a, 200b, respectively. In at least one embodiment, two or more controllers 207a, 207b of corresponding two or more security planters 200a, 200b may communicate with each other (for example, wirelessly), and may display one or more message(s) that may be split between the two or more displays of the corresponding two or more security planters 200a, 200b. In some embodiments, the displays 205a, 205b of different security planters 200a, 200b may communicate to each other directly and display similar messages(s) or split parts of the message(s) between two or more displays of the security planters 200a, 200b. For example, the message(s) displayed on the two or more security planters may provide re-routing information for the traffic or a safety and/or security-related message.

With respect to the present description, measurements, such as, for example, and without limitation, angles, lengths, widths, depth, weigh, etc. are provided herein as non-limiting examples of implementation of the technology described. The words “about”, “approximately”, or the like, when accompanying a numerical value, are to be construed as indicating a deviation as would be appreciated by one of ordinary skill in the art to operate satisfactorily for an intended purpose. For angles and lengths, a deviation of ±3 degrees or millimeters to be considered as a possible deviation.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A security planter comprising:
a container having a bottom and a groove on a first external surface of a first wall of the container, and
a first display located in the groove, the first display being attached to the container and operatively connected to a controller located inside the container.

2. The security planter of claim 1, wherein an upper edge of the first wall of the container is thinner than a first lower wall width of the first wall at a level of a bottom inner surface.

3. The security planter of claim 1, wherein a lower container portion of the container, the lower container portion, having a half of a height of the container, weighs more than 68 percent of a total weight of the container.

4. The security planter of claim 3, wherein the lower container portion weighs between 70 percent and 77 percent of the total weight of the container.

5. The security planter of claim 1, wherein the first wall of the container has a first internal surface inside the container, and the first internal surface has a first step formed on the first internal surface by three internal display surface portions, the first step increasing a width of the first wall in a groove area.

6. The security planter of claim 1, further comprising a first internal surface comprising a first internal display surface portion, a second internal display surface portion, a third internal display surface portion, wherein:
the first internal display surface portion is approximately parallel to the first external surface,
the third internal display surface portion is positioned at a first bottom internal angle, the first bottom internal angle being between the third internal display surface portion and a bottom inner surface of the container, which is larger than an external surface angle between the bottom inner surface and the first external surface; and
the second internal display surface portion connecting the first internal display surface portion and the third internal display surface portion.

7. The security planter of claim 6, wherein the first bottom internal angle is between about 110 and about 120 degrees, while the external surface angle is between about 95 and about 105 degrees.

8. The security planter of claim 1, further comprising a second groove located on a second external surface on a second wall of the container and having a second display located within the second groove, the second display being connected to the controller.

9. The security planter of claim 8, wherein a second internal surface of the second wall inside the container has a second step formed on the second internal surface.

10. The security planter of claim 1, further comprising a second wall having a second external surface and a second internal surface, the second internal surface formed by at least two surface portions forming at least one second upper angle to provide a wider lower wall width of the second wall at a level of a bottom inner surface.

11. The security planter of claim 1, further comprising at least one drain.

12. The security planter of claim 1, further comprising at least one hook located at a bottom of a container hollow extended between a first internal surface and a second internal surface of the container.

13. The security planter of claim 1, further comprising a steel rebar covered by concrete.

14. The security planter of claim 13, wherein the concrete is a 35 megapascals (MPa) concrete.

15. The security planter of claim 1, wherein external surfaces of the container have an anti-graffiti coating.

16. A system comprising a first security planter according to claim 1 and a second security planter according to claim 1, and wherein controllers of the first security planter and the second security planter are configured to communicate with each other and generate a display image being split between displays of the first security planter and the second security planter.

17. A method of manufacturing a security planter, the method comprising:
welding a rebar;
covering the rebar with concrete using a mold to manufacture a container;
polishing external surfaces of the container with at least one diamond stone in at least three stages of polishing and then sanding the external surfaces; and
after pressure washing and drying the container, applying at least one of a sealer and a coating to the external surfaces of the container.

18. The method of claim 17, wherein the coating is an anti-graffiti coating.

19. The method of claim 17, wherein the polishing with the at least one diamond stone is performed in four to six stages.

20. A security receptacle comprising:
a bottom and four walls forming a hollow with a bottom surface, wherein each wall of at least two walls has an external surface and an internal surface having an upper internal surface angle formed by an upper internal surface portion and a lower internal surface portion, and wherein:
the upper internal surface portion is approximately parallel to the external surface, and
the upper internal surface angle is between about 150 degrees and about 165 degrees,
a bottom internal angle is formed by the lower internal surface and the bottom surface being between about 119 degrees and about 129 degrees, and
a lower receptacle portion has a lower portion height of approximately half of a receptacle height of the security receptacle having weight higher than 65% of total weight of the security receptacle.
